(19) United States
(12) Patent Application Publication
(10) Pub. No.: US 2021/0277732 A1
(43) Pub. Date: Sep. 9, 2021

(54) TAPERED SHOULDER POSITION MEASUREMENT IN REAL-TIME

(71) Applicant: Schlumberger Technology Corporation, Sugar Land, TX (US)

(72) Inventors: Vishwanathan Parmeshwar, Houston, TX (US); Jaijith Sreekantan, Houston, TX (US); Pradeep Shetty, Houston, TX (US); Sreekanth Asodi, Pune (IN)

(21) Appl. No.: 16/807,869

(22) Filed: Mar. 3, 2020

(51) Int. Cl. E21B 19/16; G06T 7/73

(52) U.S. Cl. CPC E21B 19/166; E21B 19/10; E21B 19/161; G06T 7/75

(57) ABSTRACT

Systems and methods for determining a vertical position of a tool joint between two pipe segments of a drill string relative to a rig floor are disclosed. A camera or other suitable optical device is positioned to observe a drill string as it is raised and lowered out of and into a wellbore. The camera is equipped to identify a feature of the pipe segments, and based on a knowledge of the dimensions of the various pipe segments, to locate the tool joint vertically relative to the rig floor. Knowing the vertical position of the tool joint allows automatic operations to be carried out, such as assembling and disassembling the pipe segments from the drill string.

### BACKGROUND

Drilling operations in the oil and gas industry build large strings of pipe that are placed in a wellbore through a hole in the rotary table located at the floor of the rig. The strings are constructed of pipe segments that are joined together before entering the wellbore and are disconnected as the process is reversed when the time comes to remove the string. Most, but not all, of this process is automated. The joint between two pipe segments is called the tool joint, and the precise position of the tool joint is not currently measured in an efficient way. Conventional methods require a delay as measurements are taken to identify the location of the tool joint. In some cases, the measurement relies on imperfect information and is more time-consuming and inaccurate than it could be. There is a need in the art for an improved method of measuring the position of the tool joint.

### SUMMARY

Embodiments of the present disclosure are directed to a system for observing a drill string to identify a vertical location of a tool joint. The system includes a pipe assembler configured to assemble individual pipe segments together to form a string. The pipe assembler can also disassemble the string by separating pipe segments. The pipe segments individually include a box section at an upper end of the pipe segment, a pin section at a lower end of the pipe segment, and a pipe segment body between the box section and the pin section. A combination of a box section and pin section in two consecutive pipe segments forms a tool joint, and the tool joint defines a datum in a plane transverse to the string. The system also includes an optical measuring device configured to identify a feature of the pipe segment and interpret from the feature a position of the tool joint relative to the rig floor. In some embodiments individual pipe segments include a first taper between the box section and the pipe segment body, and a second taper between the pin section and the pipe segment body, and the feature of the pipe segment comprises at least one of the first and second tapers.

Other embodiments of the present disclosure are directed to a method including positioning a camera relative to a rig floor such that a field of view (FOV) of the camera includes the rig floor and a portion of a drill string, and observing the drill string as it is moved vertically relative to the rig floor, the drill string comprising a plurality of pipe segments. Individual pipe segments include a box section at an upper end, a pin section at a lower end, and a pipe segment body between the box section and the pin section. The diameter of the pipe segment body is different than a diameter of the box section and the pin section. The pipe segments also include an upper tapered shoulder region between the box section and the pipe segment body and a lower tapered shoulder region between the pin section and the pipe segment body. Consecutive pipe segments are joined together by coupling the box section of one pipe segment with the pin section of another pipe segment. The joinder of the two pipe segments defines a reference plane generally transverse to a principal axis of the drill string.

The method also includes using the camera to locate the tapered shoulder regions, and based on measurements of the tapered shoulder regions, locating the reference plane relative to the tapered shoulder regions. The method also includes locating the reference plane relative to the rig floor. In some embodiments the method further includes using the camera to locate the tapered shoulder regions, by breaking down a series of images into individual frames, executing one or more image convolutional filters to remove noise and subtract background, aligning and rotating the images to ensure translational and rotational invariance, and parsing individual frames to identify the feature.

Still further embodiments of the present disclosure are directed to a method including optically monitoring with an optical device a string of pipe segments as it is hoisted into or out of a well bore relative to a rig floor. The pipe segments have a wider portion at both ends and a tapered shoulder region between the wider portion and a middle portion. The method also includes, when a tapered shoulder region is observed to enter a field of view of the optical device, measuring a dimension of the tapered shoulder region, and identifying the tapered shoulder region as an upper end or a lower end of the pipe segment, wherein if the tapered shoulder region entering the field of view is an upper end the string is moving upward, and if the tapered shoulder region entering the field of view is a lower end the string is moving downward. The method also includes identifying from a measurement of the tapered shoulder region a vertical position of a joinder point between the pipe segment and an adjacent pipe segment, the vertical position being measured relative to the rig floor, and executing an operation on the string based on the vertical position relative to the rig floor. The operation can be to add or remove a pipe segment.

### BRIEF DESCRIPTION OF THE FIGURES

FIG. 1 is a side view of a two adjacent pipe segments forming tool a joint between them according to embodiments of the present disclosure.

FIG. 2 illustrates an image sensor of the camera according to embodiments of the present disclosure in relation to the segments with respect to a horizontal distance between the edge of field of view and the edge of the tubular.

FIG. 3 illustrates an image sensor of the camera according to embodiments of the present disclosure in relation to the segments with respect to a vertical distance between the edge of field of view and the edge of the tubular.

FIG. 4 illustrates a view of a tubular according to embodiments of the present disclosure as viewed by a camera.

FIGS. 5A and 5B depict a tubular moving downward into a well according to embodiments of the present disclosure with FIG. 5A being chronologically before FIG. 5B.

FIGS. 6A and 6B depict a tubular moving upward out of the well opposite to FIGS. 5A and 5B with FIG. 6A being chronologically before FIG. 6B according to embodiments of the present disclosure.

FIG. 7 shows a camera and a tubular according to embodiments of the present disclosure.

FIG. 8 is a flow chart of a method for counting tubular sections according to embodiments of the present disclosure.

FIG. 9 is a schematic illustration of a system for measuring position of a tool join above a reference datum such as the rig floor according to embodiments of the present disclosure.

FIG. 10 illustrates a system for integrating with control systems according to embodiments of the present disclosure.

FIG. 11 is a flow chart diagram for a method according to embodiments of the present disclosure.

### DETAILED DESCRIPTION

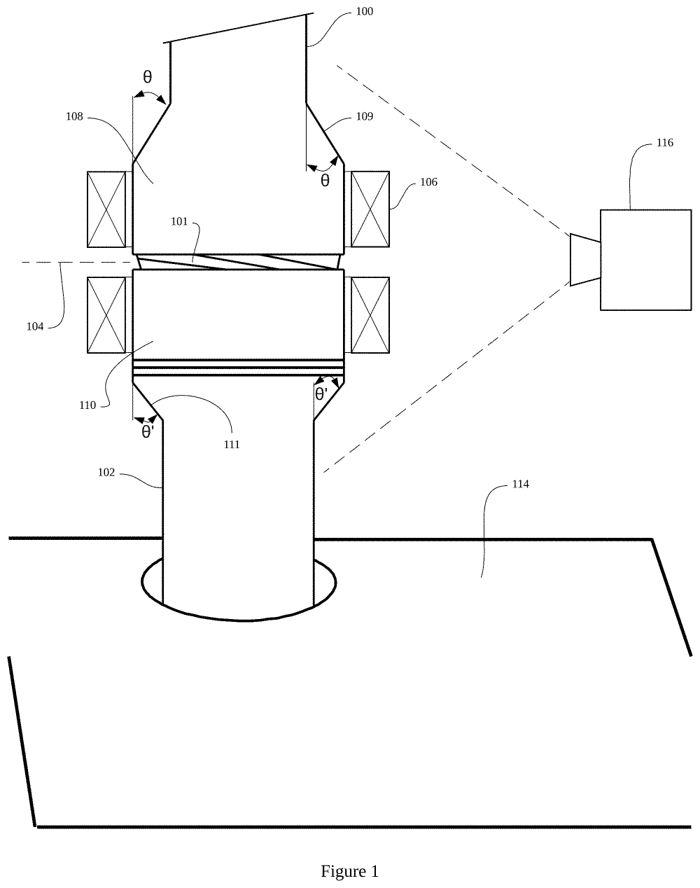

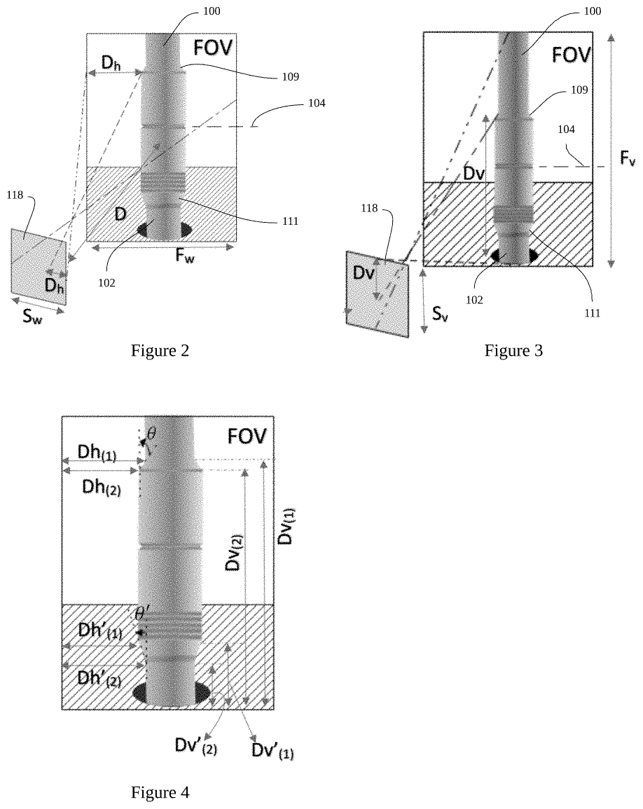

FIG. 1 is a side view of a two adjacent pipe segments forming tool a joint between them according to embodiments of the present disclosure. The first pipe segment 100 is above the second pipe segment 102, and they are shown here before being joined together to form a tool joint. FIG. 2 shows the pipe segments 100, 102 after being joined together. The union of the two segments will be referred to herein as the interface 104 and is a datum representing the lower end of the first pipe segment 100 and the upper end of the second pipe segment 102. There may be a male threaded component 101 protruding downward from the first pipe segment 100 that engages with a corresponding female threaded portion (not shown) on the second segment 102. The vertical position of the interface 104 will also be referred to herein in various embodiments of the present disclosure. In some embodiments the pipe segments 100, 102 are threadably joined together via powered tongs 106 or another suitable joining means.

The first pipe segment 100 includes an enlarged portion at the lower end called the pin 108, and a transition region between the pin 108 and the remainder of the pipe segment 100 is called the pin taper 109. The angle θ of the taper 109 can be indicative of the type of pipe that the pipe segment 100 is. There are various types and sizes of pipe, and the taper angle of each is sufficiently distinctive to allow the pipe segment to be identified based on the taper 109 alone.

The second pipe segment 102 has a similar structure including a box 110 and a taper 111 called the tapered elevator shoulder. In some embodiments each individual pipe segment has a pin at the bottom and a box at the top, the pin being the male connection and the box the female.

The pipe segments are assembled together on the rig near a rig floor 114 which has a hole through which the pipe segments pass to reach the wellbore. The rig floor 114 can be used as a reference point from which to measure the position of the interface 104 and other important identifiers. The rig floor 104 need not be the actual floor of a rig, but instead can be any arbitrary datum from which measurements are made.

In some embodiments there is a camera 116 positioned relative to the pipe segments 100, 102 such that it observes the pipe segments as they are near the rig floor 104. The camera 116 can be positioned with an orthogonal view of the pipe segments 100, 102, or with an angled view. In either case the angle of the camera 116 relative to the pipe segments 100, 102 can be taken into consideration for the calculations and operations described below. The camera 116 can be, without limitation, any remote measuring device including an optical camera, a LADAR, sonar, infrared, or any other suitable remote measuring device. For purposes of brevity herein, however, the term camera will be used without loss of generality. The camera 116 is configured to monitor the pipe segments and to identify when a taper (109 or 111) enters the field of view. This can happen from the bottom to the top if the string is moving upward or from the top to the bottom if the string is moving downward.

FIG. 2 illustrates an image sensor 118 of the camera 116 according to embodiments of the present disclosure in relation to the segments 100, 102 with respect to a horizontal distance between the edge of field of view and the edge of the tubular. In some embodiments the camera 116 has an appropriate focal length of lens and is placed in such a way that the profile of the pipe may be clearly seen. The camera 116 can be configured to find the edge of the tubular and then measure the horizontal distance from edge of the tubular to the edge of field of view. This horizontal distance (Dh) is computed using the following equation:

Dh=Nₚ×D×Cₚ

Where

Dh: Horizontal distance between the edge of field of view and the edge of the tubular;

Np: Number of pixels;

D: Orthogonal distance between the tubular and the center of camera;

Cp: Properties of camera; and

$${C}_{p} = ( \frac{{P}_{∅} \times {S}_{w}}{f \times {F}_{w}} )$$

Where

P_{Ø}: Pixel pitch of the camera sensor;

Sw: Width of the sensor;

f: Focal length of the lens; and

Fw: Image frame width;

FIG. 3 illustrates an image sensor 118 of the camera 116 according to embodiments of the present disclosure in relation to the segments 100, 102 with respect to a vertical distance between the edge of field of view and the edge of the tubular. In some embodiments the vertical distance of the object is measured by identifying a feature on the object and then computing its position from another feature within the field of view. For example, the distance between the beginning of the pin taper 109 and the lower-most part of the tubular above the rotary table may be computed using the following equation:

Dv=Nₚ×D×Cₚ

Where

Dv: vertical distance between the edge of field of view and the edge of the tubular and the beginning or end of the pin taper;

Np: Number of pixels;

D: Orthogonal distance between the tubular and the center of camera;

Cp: Properties of camera; and

$${C}_{p} = ( \frac{{P}_{∅} \times {S}_{v}}{f \times {F}_{v}} )$$

Where

P_{Ø}: Pixel pitch of the camera sensor;

Sᵥ: height of the sensor;

f: Focal length of the lens; and

Fᵥ: Image frame height;

FIG. 4 illustrates a view of a tubular according to embodiments of the present disclosure as viewed by a camera. By continuously or at least repeatedly measuring the horizontal distance of the edge of the tubular with that of the image frame, the change in the angle of the edge of the tubular taper with respect to the edge of field of view as well as the direction can be determined using the equation:

$$θ = ATA N ( \frac{D {h}_{( 2 )} - D {h}_{1}}{D {v}_{( 2 )} - D {v}_{1}} )$$

$${θ}^{′} = ATA N ( \frac{{Dh}_{( 2 )}^{′} - {Dh}_{1}^{′}}{{Dv}_{( 2 )}^{′} - {Dv}_{1}^{′}} )$$

Where

Dh₁: Computed horizontal distance between the edge of field of view and the edge of the furthest point of taper at the tool-joint pin side;

Dh₂: Computed horizontal distance between the edge of field of view and the edge of the nearest point of taper at the tool-joint pin side;

Dh′₁: Computed horizontal distance between the edge of field of view and the edge of the nearest point of taper at the tool-joint box side;

Dh′₂: Computed horizontal distance between the edge of field of view and the edge of the furthest point of taper at the tool-joint box side;

Dv₁: Computed Vertical distance between the datum reference (Rig Floor surface) and the top of the taper at the tool-joint pin side;

Dv₂: Computed Vertical distance between the datum reference (Rig Floor surface) and the bottom of the taper at the tool-joint pin side;

Dv′₁: Computed Vertical distance between the datum reference (Rig Floor surface) and the top of the taper at the tool-joint box side;

Dv′₂: Computed Vertical distance between the datum reference (Rig Floor surface) and the top of the taper at the tool-joint box side;

θ: Angle between the pin taper and vertical; and

θ′: Angle between the taper elevator shoulder (the taper at the upper end of the pipe segment) and vertical;

The angle (θ) and (θ′) may have a positive value or a negative value depending upon the inclination of the taper towards or away from the FOV edge.

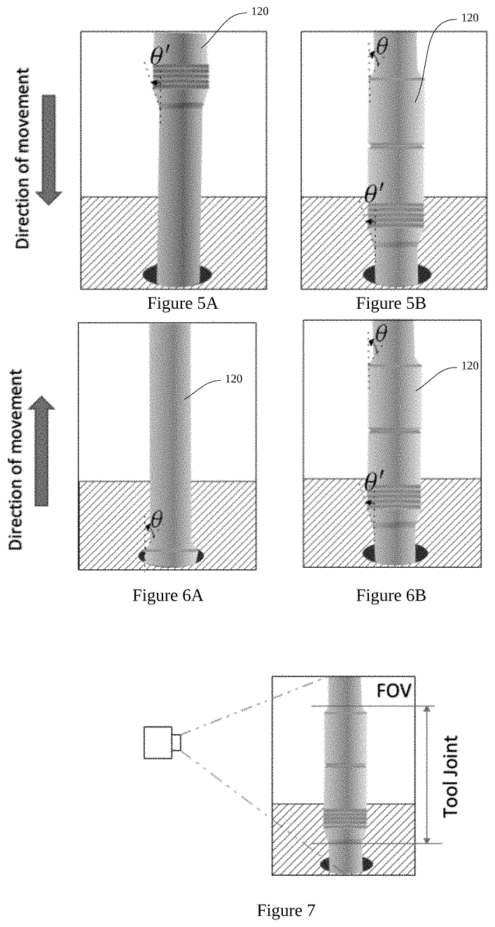

FIGS. 5A and 5B depict a tool joint unit 120 moving downward into a well according to embodiments of the present disclosure with FIG. 5A being chronologically before FIG. 5B. FIGS. 6A and 6B depict a tool joint unit 120 moving upward out of the well opposite to FIGS. 5A and 5B with FIG. 6A being chronologically before FIG. 6B according to embodiments of the present disclosure. The direction of movement of the tubular may be determined based on detection and measurement of “(θ)” and “(θ′)”. If “(θ)” is detected first followed by “(θ′)” then the pipe is moving up while detection of “(θ′)” followed by “(θ)” indicates pipe moving down. In another embodiment, the appearance of the tapers from the top of the FOV or from the bottom may indicate the movement of the pipe.

FIG. 7 shows a camera 116 and a tool joint unit 120 according to embodiments of the present disclosure. The camera 116 can be placed in a fixed position overlooking the movement of the tool joint unit 120 in or out of the wellbore. There can be a computation component coupled to the camera 116 and configured to make calculations and judgements regarding the position of the tool joint unit 120. A software algorithm executed by the computation component can use the video (captured by the camera in real time) and can identify the presence or absence of the tool joint unit that consist of a union of the Tool joint pin to the Tool joint box. Once the Tool joint is recognized, the algorithm updates the tool joint count based on the movement of drill pipe. It can add to the count if the movement of the tool joint is from the top of the frame and moving down, or subtract the count based on the movement of the tool joint from bottom of the frame towards the top. The cumulative count maintained by the software represents the total tubular run in hole or removed from the hole.

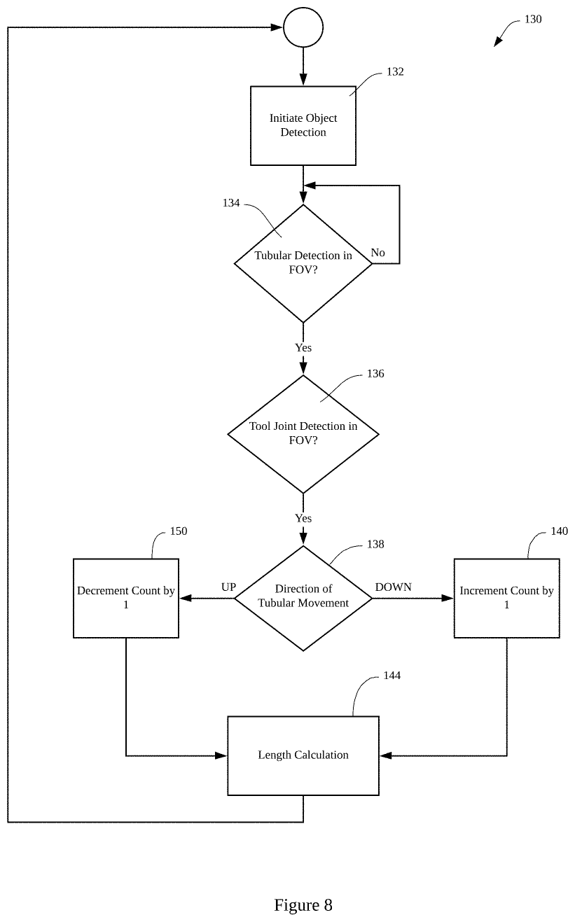

FIG. 8 is a flow chart of a method 130 for counting tubular sections according to embodiments of the present disclosure. The method 130 can be iterative and can run any number of times as needed for a given assembly or disassembly of the tubular. The method 130 can be initiated at 132 by an operator or another local or remote device. At 134 the method observes the tubular and an object enters the field of view (FOV) of the camera that is identified as the tubular. At 136 the tubular continues to be observed and a tool joint unit is identified such as by identifying a taper on the box or pin joint of the tubular section. In some embodiments the angle and length of the taper can be measured by the camera's detection and analysis mechanisms. In some embodiments the angle and/or length of the taper can be sufficient to identify the type of tubular section that is present in the FOV.

At 138 the direction of tubular movement is determined using the techniques described above by calculating whether the angle of the first taper to enter the FOV is positive (θ) or negative (θ′). If the angle is positive (θ) the tubular is moving downward into the hole and at 140 the method increments the count by one. The order of detection can be used to determine a positive or negative angle. If the angle is negative (θ′) the tubular is moving upward out of the hole and at 150 the method decrements the count by one. The order of detection (θ) or (θ′) can be used to make the determination. If the order is (θ) first and (θ′) second, the pipe is moving up and the reverse order means the pipe is moving down.

At 144 the method can also include a length calculation process by which the length of the entire tubular string is calculated. The length calculation process can identify the type of tubular section from the angle and/or length of the taper alone, and can access a look-up table based on a count to identify the length of the section and can add the length of the section to the overall tubular. Accordingly, by using the method 130 an operator can know the number of tubular sections that are below the rig floor and the length of the string that is below the rig floor. Conversely, at 150 if the pipe is moving upward and pipe segments are being removed from the string at 140 the method can include subtracting from the total count. Here the method can call the length calculation portion 144 of the method including any one or more of accessing a look-up table and subtracting (negative adding) to the length. The method can then return to 132 where the next pipe connection object is detected optically and the process repeats. The result is at all times an operator will know the number of pipe segments in the string below the rig floor and the length of the string below the rig floor, and these data are obtained automatically and in real-time. Previous techniques have required a stoppage and measurement to obtain the data, or the data was unattainable.

The tool joint pin and the tool joint box are beveled called the connection bevel that are in contact with each other when the tubulars are made up. The length between the top of the taper and the face of the connection bevel (pin side)—“Lp” is a property of the tubular. Similarly, the length between the bottom of the taper and the face of the connection bevel (box side)—“Lb” is a property of the tubular. This distance is measured and maintained as a configuration of the pipe in a look up table.

The vision system first detects the appearance of the Tool joint in the field of view. It then measures the distance between the top of the taper and the datum reference (Rig floor)—Dv(1). The system then calculates the location of tool joint by performing the following calculation:

PTJ=Dv₁+Lₚ

PTJ=Dv′₂+L_{b}

Where

PTJ: Position of Tool joint from reference rotary table or reference plane

Lp: Lengths of pin from lookup table

Lb: Lengths of box from lookup table

Similarly,

PTJ′=Dv₁+Lₚ′

PTJ′=Dv′₂+L_{b}′

Where

PTJ′: Position of the lower tool joint from reference rotary table or reference plane

Lp′: Lengths of pin from lookup table

Lb′: Lengths of box from lookup table

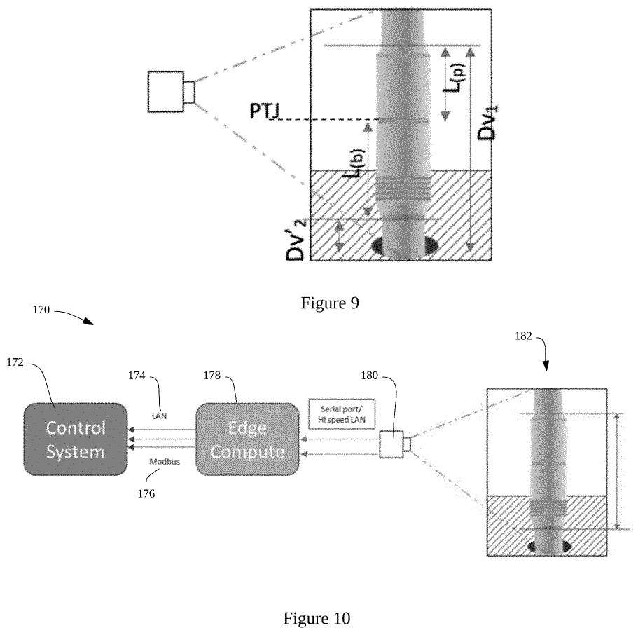

FIG. 9 is a schematic illustration of a system for measuring position of a tool joint above a reference datum such as the rig floor according to embodiments of the present disclosure. When the vision system detects the appearance of taper, either box side or pin side, vision system calculates the distance Dv′2 or Dv1 distance as maybe the case. The position of the string can be controlled by a hoisting device such as a rotating drum coupled to a cable that hoists the string. The rotating drum can be controlled by the control system. This value is then passed to the control system which in-turn computes a number of rotations of the drum to reach a fixed setpoint for the position of the tool joint from the reference rotary table. To control system computes the number of turns using the following equations:

ΔD=Dₛ−PTJ

Where

PTJ: Position of Tool joint

Dₛ: Vertical distance setpoint from the rig floor reference datum

ΔD: Vertical distance the position of tool joint need to travel to arrive at set point

L_{c}=ΔD×Nₗ

Where

L_{c}: total length of drill line that must be wound on the drum or unwound

Nₗ: Number of lines between the Travelling block and crown block

$${T}_{D} = ( \frac{{L}_{c}}{{L}_{n}} )$$

Where

T_{D}: Number of turns the drum needs to be rotated to wind or unwind the drill line

Lₙ: Length of one turn of drill line on “n” layer of the drum

Lₙ=π×(D_{d}+C_{d}+((n−1)×(√3×C_{d})))

Where

D_{d}: Drum Diameter

C_{d}: Drill line diameter

n: Number of complete layers on the drum

Tₛ=T_{cl}+T_{D}

Where

Tₛ: Number of turns command by control system

T_{cl}: Current layers and turn on the last layer when the position of tool joint data is received.

According to embodiments of the present disclosure, a control system can be configured to calculate the turns of drum required to engage the tubular on slips while maintaining the fixed setpoint for the position of the tool joint from the reference rotary table.

In another embodiment, the detection of the tool joint is passed by the control system to a pipe tally application to update the current tubular running in or being pulled out of the well bore, pass the current position of the tool joint, above the rotary table, so that the total length of string below the rotary table may be calculated by the pipe tally application. This may be applied to both Drill pipe and casing tally.

In some embodiments the operator desires to fill up the drill pipe and/or casing, and knowing the length of the string below the wellbore will allow the operator to do this effectively. The internal dimensions of the pipe segments is known and can be referenced and together with knowing the length of the string allows a simple calculation to determine how much fluid is needed to fill the interior of the string. Previous methods involved guess work and trial an error which can be costly and error-prone. This applies more particularly when the end of the drill string is closed and is designed to hold the fluid inside the string.

For object detection based on the edge device, the video of a pipe taken @ 120 fps or another suitable frame rate is broken down into individual image frames. Each image is preprocessed and pass through multiple image convolutional filters for feature extractions of the object under consideration after removing weather conditions, removing noise, and subtracting background as detailed below. Further they are aligned and rotated to make sure the algorithm is translational and rotationally invariant. Each frame is parsed to initially identify if an object of interest is in place. In some embodiments the object of interest can be the tapered shoulder. If an object of interest is in place, the model proposes the region of interest to look for to the next layers of the model and the next layers measures the coordinates of the said object of interest. All frame thus classified are voted out to get the best possible outcome and returned my minimizing the total loss function. The neural network architecture is further optimized for speed by reducing the hyperparameters need for tuning by introducing depth wise separable convolutions and linear bottleneck layers to achieve a state-of-the-art frame processing rate. High speed tracking using kernelized correlation filters are used to track tapered shoulder identified in each frame of the video to maintain its unique identity. Such identity of each tapered shoulder in a video stream is used for counting and tallying against records. The details of the deep neural network architecture are listed below.

Classification Network

For classification, a convolutional neural network architecture can be used as the base. To advance the model accuracy we introduce additional features listed below. We avoid early bottlenecks in the model, let the acyclic graph be easily represented with a feed forward model from input to the regressor or classier. More important, avoid dropping big dimensions, and do it gradually from input to output, ensure not to lose useful correlations values for the task. We can obtain a faster train using high dimensions representations and by the activations per tile's increase in the convolutional network. To boost accuracy, we reduce dimensions before parameters aggregations due to the high correlation between adjacent units. The more the model is balanced, the more the learning is consistent. Accordingly we can raise in parallel width and depth of the network adding filters where needed. We also incorporated depth wise convolution features for faster run time. Accordingly we replace a full convolutional operator with a factorized version that splits convolution into two separate layers. The first layer is called a depth wise convolution. It performs lightweight filtering by applying a single convolutional filter per input channel. The second layer is a1×1 convolution, called a pointwise convolution, which is responsible for building new features through computing linear combinations of the input channels.

Proposal Network

For localization of the models, we have built region proposal network (RPN) integrated along with the convolutional neural network stated above. The regional proposal network works on selective search features. The RPN network is to pre-check which location contains an object. And the corresponding locations and bounding boxes will pass to detection network for detecting the object class and returning the bounding box of that object. As regions can be highly overlapped with each other, non-maximum suppression (NMS) is used to reduce the number of proposals from thousands to a couple of hundreds. For the thus nominated proposal, region of interest pooling is performed first. And then the pooled area goes through convolutional neural network and fully connected branches for class SoftMax and bounding box regressor.

Object Tracking Module

For high speed tracking of the detected tapered joints, we adopted a new tracking algorithm guided by the understanding of the objects under purview. Given the initial set of points, a tracker tries to calculate the motion of these points by looking at the direction of change in the next frame. Within a predetermined series of frames, we try to look for the same set of points in the neighborhood. Once the new positions of these points are identified, we can move the bounding box over the new set of points. The process is further enhanced to improve accuracy by getting information about the geometry of the pipe being monitored. With prior understanding of the pipe geometry and relative orientation in the scene, tracked objects stickiness is highly increased and the identity is continuously maintained without any loss of information. This guided tracking enables high reliability of the system. In some embodiments the reliability is approaching 100%.

Background Subtraction:

[[Give the algorithm the time of day and/or weather information to use to do the background subtraction. It is a learning algorithm that can learn from this input and from the optical picture what to subtract from the background. Analog to a self-driving car using LIDAR. It also has optics. So for us, we have the optical picture in addition 1. Time of day and 2. Weather. 3. Location information, etc. It can also be system information, the land rig the equipment present. What kind of job the project is running. If it is a land rig or a deep water rig the situation will be different. It is used to understand how good the tide is. “adaptive filter.” “reinforcement learning” and not supervised learning.

Another thing: camera is out of focus. We can use a raspberry pi thing to get the camera to come back to focus mode.

Semantic background subtraction is used to subtract background and enhance motion detection in video sequences. According to embodiments of the present disclosure, a self-evolving model with prior information of the weather condition at the location and time of the day is used. The model can periodically ingest the time of day as the current state to the system to perform background [subtraction??] with changing environmental conditions. The model can continuously evolve using reinforcement learning framework and learns to self-adjust the background that needs to be subtracted through a reward mechanism. The reward mechanism can be defined with respect to a similarity measure of the number of pixels of the subtracted scene vs the ground truth of just the object under consideration. Accordingly we leverage object-level semantics to address the variety of challenging scenarios for background subtraction. The algorithm combines the information of a semantic segmentation algorithm, expressed by a probability for each pixel, with the output of background subtraction algorithm to reduce false positive detections produced by illumination changes, dynamic backgrounds, strong shadows, and ghosts. The background subtraction algorithm is a Gaussian Mixture-based Background/Foreground Segmentation Algorithm for real-time tracking with shadow detection. To improve the model, we added fusing depth and color inputs. For depth perception, the algorithm makes sense of the depth of the vision from the camera position to the object of interest. This identifies corners of the tapered shoulder and velocity of motion. The model generates depth maps where the original 2D image RGB pixel values are overlaid with an array of values representing the distance from the camera to the spot where the light representing the pixel originated. To this depth we infuse color to take advantages of local texture features represented by local binary patterns (LBP) and photometric invariant color measurements in RGB color space. LBP can work robustly with respective to light variation on rich texture regions but not so efficiently on uniform regions. In the latter case, color information should overcome LBP's limitation. Due to the illumination invariance of both the LBP feature and the selected color feature, the method can handle local illumination changes such as cast shadows from moving objects.

Weather Conditions and Noise Removal:

Rain/Fog

The algorithm learns negative residuals caused by different environmental conditions such as rain/fog etc. The algorithm learns to differentiate for example between clean and rainy images by observing and predicting the residual between the two.

For example, if we denote the input rainy image and corresponding clean image as X and Y, respectively. Intuitively, a goal may be to directly train a deep CNN architecture h(X) on multiple images to minimize the objective function

L=Σᵢ|h(Xi)−Yi|2 where the norm is Frobenius norm.

Shadows

Within the rig, the shadow areas are less illuminated than the surrounding areas. Though in some cases, the shadows provide useful information, such as the relative position of an object from the source but they cause problems in our tapered shoulder detection problem and hence removal is a major pre-processing task. The model addressed both hard and soft shadows.

We developed an invariant image formation model and aims to separate an image into its reflectance and illumination components. Reflectance component will be invariant to both color and intensity of the scene and hence it will be shadow free. The model defines an image I(x,y) as composed of reflectance component R(x,y) and the illumination component L(x,y) as follows.

Ik(x,y)=Rk(x,y)·Lk(x,y)

where k is element of R, G, B and ‘·’ denotes pixel-wise multiplication. In shadow regions illumination is reduced and image intensities are reduced by multiplicative scalars of Ck(x, y). Thus, the above equation can be rewritten as:

Ik(x,y)=Rk(x,y)·Lk(x,y)·Ck(x,y)

Now, to calibrate the camera, illumination-invariant image is used with the original color image to locate the shadow edges. The edge representation is reintegrated, and edges are set to zero to get the shadow-free image. Further processing is performed by adding Shadow edge detection using geometric and photometric features using annotated images labelled as either containing a shadow edge or not. Then, the geometric features of these patches are analyzed and a classifier is trained to distinguish between shadow and non-shadow patches. The combination of photometric and geometric features is exploited for classification of shadow edges in addition to using either photometric or geometric features.

Reflections

Object reflections in windows and against shiny buildings can cause false events, and eliminate such reflections where possible. We developed a multiple-image method for removal of reflection. The model can be represented as a linear combination of the background B and reflection R: The i-th image is represented as

Ii(x)=αiLB(x)+βiLR(x),

where combination coefficients αi and βi can be estimated by taking a sequence of images using special devices or in different environments.

Night Scenes

Analytics can function on night scenes to a greater or lesser extent, depending on the lighting and the camera setup. Objects are detected to some extent, depending on the underlying detection methodology, but headlight bloom can cause significant problems, and details like color might not be apparent to a human observer. To achieve reasonable performance at night, artificial lighting is used. We also incorporated thermal and infrared cameras and have built detection models on thermal and infrared image footprint. Added to this, with the background subtraction algorithm as mentioned above, we are able to capture the foreground moving object which is the tapered shoulder with good precision and recall.

Dirt or Dust on the Camera Lens

Dirt on the camera lens can obscure or blur objects and reduce contrast. As a result, the image quality is poor. To avoid such circumstance, an automated calibration of the camera and testing for image quality is performed by template matching with the best of images. If the test fails and the problem is prevalent on cameras, an alarm is indicated to the operators that performance is affected and that the lens is not kept clean.

Obstructions

Large obstructions can break the track of a single object into multiple short segments. This can adversely affect the count of pipe tally as well as detection of tapered shoulder under consideration. An alarm is raised if there is an obstruction in the field of vision. We also have established cameras modules at the three identified triangulated points in the rig to capture the tapered shoulder as a fall back mechanism as well as to have better invariance to environmental factors.

Integrating with Control Systems

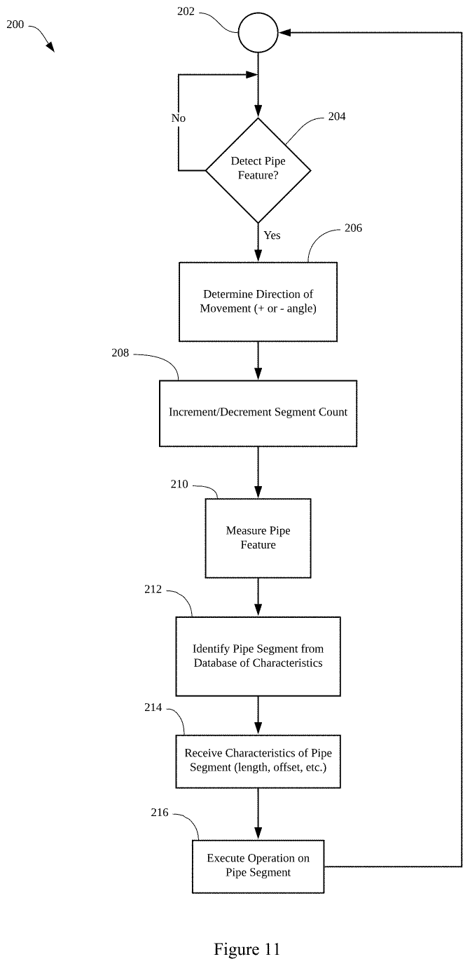

FIG. 10 illustrates a system 170 for integrating with control systems according to embodiments of the present disclosure. A control system 172 is operatively coupled to an edge computing component 178 via a connection mechanism such as a local area network (LAN) 174 or a Modbus 176 or other suitable connective means. The edge computing component can include a GPU with the capability to provide real time detections of tool joint. A camera sensor 180 is connected to edge computation component 178 by either serial or over network such as on a wired local LAN. By optimizing vision model and reducing video frame dimensions a framerate of 30 FPS or more may be achieved. This allows instantaneous detection of tool joint the moment it appears within field of vision allowing triggers to be sent from edge device to control system which in turn can trigger pipe tally application.

FIG. 11 is a flow chart diagram for a method 200 according to embodiments of the present disclosure. At 202 the method can initiate by utilizing a camera viewing a rig floor and pipe string as it is being assembled or disassembled as has been described herein. The camera is configured to measure optically features of the pipe segments and the rig floor and to calculate certain distances as has been described above in detail. The method 200 can run iteratively as often as needed, including as often as once every pipe segment. At 204 the camera optically views the pipe and continuously strives to identify a pipe feature, such as a taper at the upper or lower end of pipe segments. As the pipe segment moves into or out of the well, most of the time the camera will view a cylindrical pipe and therefore at 204, no pipe feature is detected. The sample rate of the camera can be 120 hertz or another suitably high number sufficient to have multiple frames in which the pipe feature is in the frame. In some embodiments the sample rate of the camera is chosen relative to the movement speed of the pipe segment to prevent the camera from missing a pipe feature.

The pipe feature can be any distinguishing mark or shape of the pipe segment. In some embodiments the pipe feature is a taper angle at the upper or lower end of the pipe segment. The angle of the taper can be measured by the camera. At 206 once the pipe feature is detected, the method includes determining a direction of movement of the pipe feature. This can be achieved by comparing successive frames in the optical feed. In other embodiments the angle can be measured as being either positive (θ) or negative (θ′) (at least partially based on the order of appearance in the field of view. Refer to FIG. 4), wherein a positive angle entering first signaling the pipe is moving upward and a negative angle entering first signaling the pipe is moving downward. At 208 the segment count is accordingly updated: upward movement signals a pipe segment is to be removed and the pipe segment count decremented; downward movement signals a pipe segment is to be added and the pipe segment count incremented.

At 210 the pipe feature is measured. It is to be appreciated that the order of certain steps in the method 200 can vary and is not necessarily performed in the order shown here. The dimensions of the pipe feature can include a length of the taper section, an angle of the taper portion, and a count of pipe segment. At 212, the measured pipe feature is sent to a database equipped with a computer or some suitable calculation mechanism configured to identify the pipe segment based on the measurements. In some embodiments this is achieved using a database having a look-up table. From the measurement, the pipe segment can be identified. At 214 the database can deliver characteristics of the pipe segment, including length of the pipe segment, type of the pipe segment, size and location of hard bands, and offset. Offset is defined as a vertical distance between the taper and the end of the pipe segment. The offset can be used to identify with precision the vertical position of the upper-most or lower-most reach of the current pipe segment. This information is then used to assist joining or removing the next adjacent pipe segment. At 216 an operation is executed using the information provided by the method 200. The operation can be to remove a pipe segment in which case powered tongs or other suitable torqueing mechanism can grasp the pipe segments at an appropriate place, avoiding hard bands (if so desired), and applying an appropriate torque to disengage the pipe segments. If the operation is to add a pipe segment, the process is to align a new pipe segment, apply necessary torque for a known quantity of rotations until the pipe segments are aligned.

The foregoing disclosure hereby enables a person of ordinary skill in the art to make and use the disclosed systems without undue experimentation. Certain examples are given to for purposes of explanation and are not given in a limiting manner.

1. A system, comprising:
a pipe assembler configured to assemble individual pipe segments together to form a string, the pipe assembler being also configured to disassemble the string by separating pipe segments, wherein the pipe segments individually include a box section at an upper end of the pipe segment, a pin section at a lower end of the pipe segment, and a pipe segment body between the box section and the pin section, wherein a combination of a box section and pin section in two consecutive pipe segments forms a tool joint, the tool joint defining a datum in a plane transverse to the string; and
an optical measuring device configured to identify a feature of the pipe segment and interpret from the feature a position of the tool joint relative to the rig floor.

2. The system of claim 1 wherein individual pipe segments include a first taper between the box section and the pipe segment body, and a second taper between the pin section and the pipe segment body, and wherein the feature of the pipe segment comprises at least one of the first and second tapers.

3. The system of claim 1 wherein the optical measuring device is further configured to monitor movement of the string as it moves upward out of a wellbore and downward into the well bore.

4. The system of claim 1 wherein the optical measuring device is further configured to:
calculate motion of an initial set of points in a first frame, the set of points being confined to a bounding box
analyze a direction of change in the set of points in a subsequent frame by identifying the set of points in the subsequent frame as being near the set of points in the first frame; and
moving the bounding box according to the set of points in the subsequent frame.

5. The system of claim 4 wherein the optical measuring device is further configured to receive a shape of the pipe segments for an initial estimate of the initial set of points.

6. The system of claim 1 [this is to be a claim of “background subtraction” according to paragraph [0116]. I need more information to compete the claim.

7. The system of claim 1 wherein the pipe assembler comprises powered tongs configured to grasp the pipe segments and apply a predefined torque to assemble or disassemble the pipe segments, and wherein the powered tongs are configured to grasp the pipe segments based on the position of the tool joint relative to the rig floor.

8. The system of claim 7 wherein the optical measuring device is configured to identify individual pipe sections and to access a database containing information pertaining to the individual pipe segments including the predefined torque pertaining to the individual pipe segments.

9. The system of claim 1, further comprising a database of information pertaining to individual pipe segments, wherein the optical measuring device is configured to identify a type of pipe segment based on the feature, and to access the database to retrieve information pertaining to the individual pipe segment.

10. The system of claim 9 wherein the information pertaining to the individual pipe segments comprises a length of at least one of the pin section or the box section, wherein at least one of the pin section and box section includes a taper between the pipe segment body and the pin section or box section.

11. The system of claim 9 wherein the information pertaining to the individual pipe segments comprises a position of hard bands on the pipe segment, wherein the pipe assembler is configured to be instructed to avoid grasping the hard bands.

12. The system of claim 9, further comprising a string length calculator configured to maintain a progressive count of pipe segments as they are added to or removed from the string, wherein the string length calculator is further configured to access a length of individual pipe segments, whereby a combination of the progressive count and the length of each pipe segment results in a total length of the string during assembly or disassembly.

13. The system of claim 1, further comprising a hoist mechanism configured to raise and lower the string, and wherein the hoist mechanism is configured to communicate with the optical measuring device to position the string at a desired location relative to the rig floor.

14. The system of claim 13 wherein the hoist mechanism comprises a rotating drum and wherein the position of the string is determined by a number of rotations of the rotating drum.

15. The system of claim 13, further comprising slips below the rig floor, wherein the hoist mechanism is configured to position the string relative to the slips to set the slips to secure the string to the slips.

16. The system of claim 9 wherein the information comprises an internal volume dimension for individual pipe segments to permit a calculation of a total internal volume for the string by adding the internal volume of the pipe segments.

17. The system of claim 1 wherein the optical measuring device is configured to:
break down a series of images into individual frames;
execute one or more image convolutional filters to remove noise and subtract background;
align and rotate the images to ensure translational and rotational invariance; and
parse individual frames to identify the feature.

18. The system of claim 17, wherein the optical measuring device is further configured to implement a classification network, a proposal network, an object tracking module, and environmental residual removal.

19. A method, comprising:
positioning a camera relative to a rig floor such that a field of view (FOV) of the camera includes the rig floor and a portion of a drill string;
observing the drill string as it is moved vertically relative to the rig floor, the drill string comprising a plurality of pipe segments, wherein individual pipe segments comprise:
a box section at an upper end;
a pin section at a lower end;
a pipe segment body between the box section and the pin section, wherein the diameter of the pipe segment body is different than a diameter of the box section and the pin section;
an upper tapered shoulder region between the box section and the pipe segment body;
a lower tapered shoulder region between the pin section and the pipe segment body; and
wherein consecutive pipe segments are joined together by coupling the box section of one pipe segment with the pin section of another pipe segment, wherein the joinder of the two pipe segments defines a reference plane generally transverse to a principal axis of the drill string;
using the camera to locate the tapered shoulder regions;
based on measurements of the tapered shoulder regions, locating the reference plane relative to the tapered shoulder regions; and
locating the reference plane relative to the rig floor.

20. The method of claim 19, further comprising:
accessing a database containing dimensions of the pipe segments;
identifying an individual pipe segment in the database;
accessing a dimension of the pipe segment, wherein the dimension of the pipe segment is used to locate the reference plane relative to the rig floor.

21. The method of claim 19 wherein using the camera to locate the tapered shoulder regions comprises:
breaking down a series of images into individual frames;
executing one or more image convolutional filters to remove noise and subtract background;
aligning and rotating the images to ensure translational and rotational invariance; and
parsing individual frames to identify the feature.

22. The method of claim 19, further comprising at least one of:
coupling a pipe segment to the string using the location of the reference plane relative to the rig floor; and
uncoupling a pipe segment from the string using the location of the reference plane relative to the rig floor.

23. The method of claim 19, further comprising identifying a position of hard bands on the pipe segment and directing a grasping device to avoid grasping the hard bands.

24. The method of claim 19, further comprising:
identifying a direction of travel of the pipe segments by observing with the camera movement of the tapered shoulder regions; and
maintaining a count of pipe segments as pipe segments are added to and removed from the string by incrementing the count each a time tapered shoulder region is observed by the camera if the direction of travel is down, and decrementing the count each time a tapered shoulder region is observed by the camera if the direction of travel is up.

25. The method of claim 19, further comprising measuring an angle of the tapered shoulder region to determine whether the tapered shoulder region as it first enters the FOV of the camera is a box section or a pin section, wherein a box section entering first is interpreted as the string is moving downward, and wherein a pin section entering first is interpreted as the string moving upward.

26. A method, comprising
optically monitoring with an optical device a string of pipe segments as it is hoisted into or out of a well bore relative to a rig floor, wherein the pipe segments have a wider portion at either end and a tapered shoulder region between the wider portion and a middle portion;
when a tapered shoulder region is observed to enter a field of view of the optical device:
measuring a dimension of the tapered shoulder region;
identifying the tapered shoulder region as an upper end or a lower end of the pipe segment, wherein if the tapered shoulder region entering the field of view is an upper end the string is moving upward, and if the tapered shoulder region entering the field of view is a lower end the string is moving downward;
from a measurement of the tapered shoulder region, identifying a vertical position of a joinder point between the pipe segment and an adjacent pipe segment, the vertical position being measured relative to the rig floor; and
executing an operation on the string based on the vertical position relative to the rig floor.

27. The method of claim 26, further comprising after executing the operation, resetting the optical device to monitor for a next tapered shoulder region to enter the field of view.

28. The method of claim 26, wherein the operation comprises one of adding a new pipe segment or removing a pipe segment, the method further comprising maintaining a count of the pipe segments added to or removed from the string.

29. The method of claim 26, further comprising maintaining a length of the string by adding lengths of the pipe segments are they are added to or removed from the string.
